(19) United States
(12) Patent Application Publication
(10) Pub. No.: US 2026/0352126 A1
(43) Pub. Date: Nov. 5, 2026

(54) PROCESSING CIRCUIT FOR A MAGNETIC SPEED SENSOR

(71) Applicant: Haier US Appliance Solutions, Inc., Wilmington, DE (US)

(72) Inventors: Nathaniel Lehrer, Louisville, KY (US); Andrew L. Reder, Louisville, KY (US)

(21) Appl. No.: 19/194,105

(22) Filed: Apr. 30, 2025

(51) Int. Cl. H02P 6/17; D06F 34/08; D06F 34/14; D06F 37/30; D06F 103/24; D06F 105/48; G01P 3/48

(52) U.S. Cl. CPC H02P 6/17; D06F 34/08; D06F 34/14; D06F 37/304; G01P 3/4802; D06F 2103/24; D06F 2105/48

(57) ABSTRACT

A motor drive circuit for controlling a motor in an appliance is provided. The motor drive circuit includes an inverter configured to provide power to the motor. The motor drive circuit further includes a controller configured to control the inverter. The motor drive circuit further includes a processing circuit coupled to a magnetic sensor configured to provide a sensor signal indicative of a speed of the motor, the processing circuit configured to process the sensor signal to provide a processed sensor signal. The processing circuit includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

### FIELD

Example aspects of the present disclosure relate generally to a processing circuit for a magnetic speed sensor for determining a motor speed of a motor in an appliance.

### BACKGROUND

During operation of a motor, such as operation of a motor in an appliance, a magnetic sensor (e.g., magnetic pickup sensor) may be configured to measure a speed (e.g., rotational speed) of the motor.

### SUMMARY

Aspects and advantages of embodiments of the present disclosure will be set forth in part in the following description, or can be learned from the description, or can be learned through practice of the embodiments.

One example aspect of the present disclosure is directed to a motor drive circuit for controlling a motor in an appliance. The motor drive circuit includes an inverter configured to provide power to the motor. The motor drive circuit further includes a controller configured to control the inverter. The motor drive circuit further includes a processing circuit coupled to a magnetic sensor configured to provide a sensor signal indicative of a speed of the motor, the processing circuit configured to process the sensor signal to provide a processed sensor signal. The processing circuit includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

Another example aspect of the present disclosure is directed to a processing circuit for processing a sensor signal indicative of a speed of a motor provided by a magnetic sensor in an appliance, the processing circuit configured to process the sensor signal to provide a processed sensor signal. The processing circuit includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

Another example aspect of the present disclosure is directed to a washing machine appliance. The washing machine appliance includes a motor. The washing machine appliance further includes a magnetic sensor configured to provide a sensor signal indicative of a speed of the motor. The washing machine appliance further includes a motor drive circuit The motor drive circuit includes an inverter configured to provide power to the motor. The motor drive circuit further includes a controller configured to control the inverter. The motor drive circuit further includes a processing circuit configured to process the sensor signal to provide a processed sensor signal. The processing circuit further includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

These and other features, aspects and advantages of various embodiments will become better understood with reference to the following description and appended claims. The accompanying drawings, which are incorporated in and constitute a part of this specification, illustrate embodiments of the present disclosure and, together with the description, serve to explain the related principles.

### BRIEF DESCRIPTION OF THE DRAWINGS

Detailed discussion of embodiments directed to one of ordinary skill in the art are set forth in the specification, which makes reference to the appended figures, in which:

FIG. 1 illustrates a perspective view of an example appliance according to example embodiments of the present disclosure;

FIG. 2 illustrates another perspective view of the example appliance of FIG. 1 with a door of the appliance shown in an open position;

FIG. 3 provides a front, cross-sectional view of the example appliance of FIG. 1;

FIG. 4 provides a block diagram depicting an example motor drive circuit according to example embodiments of the present disclosure;

FIG. 5 provides a plot depicting an example filtering scheme of a processing circuit according to example embodiments of the present disclosure;

FIG. 6 provides a circuit schematic of an example processing circuit according to example embodiments of the present disclosure;

FIG. 7 provides a graphical representation of example signals of an example processing circuit according to example embodiments of the present disclosure;

FIG. 8 provides a graphical representation of example signals of an example motor drive circuit according to example embodiments of the present disclosure during a startup mode of an appliance; and

FIG. 9 provides a graphical representation of example signals of an example motor drive circuit according to example embodiments of the present disclosure during a top speed mode of an appliance.

Repeat use of reference characters in the present specification and drawings is intended to represent the same and/or analogous features or elements of the present invention.

### DETAILED DESCRIPTION

Reference now will be made in detail to embodiments, one or more examples of which are illustrated in the drawings. Each example is provided by way of explanation of the embodiments, not limitation of the present disclosure. In fact, it will be apparent to those skilled in the art that various modifications and variations can be made to the embodiments without departing from the scope or spirit of the present disclosure. For instance, features illustrated or described as part of one embodiment can be used with another embodiment to yield a still further embodiment. Thus, it is intended that aspects of the present disclosure cover such modifications and variations.

A motor generally refers to a class of electro-mechanical device that is capable of producing revolving motion in response to electrical signals. A motor may typically include a stationary, typically mounted, stator configured to encase or surround a rotor. The rotor and/or stator are electrically and/or magnetically charged to induce rotational motion between the rotor and the stator. The motor may be included in an appliance, such as a washing machine. As used herein, the term “motor speed” refers to a rotational speed of a motor, such as the rotational speed of a rotor or shaft of the motor measured in hertz (Hz) or rotations per minute (RPM). In some embodiments, a motor shaft may be coupled via a belt and pulley to a wash basket. The wash basket may be geared down to produce more torque while rotating at a lower speed. As such, motor speed may be determined based on the rotational speed of the wash basket.

In some appliances, a magnetic sensor (e.g., magnetic pickup sensor) may be configured to detect a speed of the motor (e.g., rotational speed of a rotor of the motor). For instance, a magnetic sensor may be passively coupled proximate to a component on the rotor shaft. As the rotor is rotated, the magnetic permeability of the space near the sensor may change as portions of the component rotates into and out of the sensed area, thereby producing a sensor signal corresponding to the rotor speed. For instance, this changing magnetic permeability may occur due to type/geometry of the rotating component (e.g., gear teeth of a rotor). However, electrical noise, such as high-frequency noise produced by electronics that drive the motor, may corrupt the sensor signal.

For instance, inverter driven motors may produce an electrically noisy environment. This noise can make signal processing and system control difficult as a corrupted sensor signal may produce poor motor speed measurements upon which the system may be controlled. The high dV/dt signals associated with inverters may create common-mode noise sources which can couple into harnesses and affect sensitive electronics such as the circuit connected to the output of the magnetic pickup sensor. These noise sources can take multiple paths to said circuitry and have the potential to present as either common-mode and/or differential-mode noise by the time that the noise is incident to the sensor input circuitry.

In addition, the output voltage of the sensor signal may be much smaller at low motor speeds when compared to the output voltage at a top motor speed. For instance, the output voltage of the magnetic sensor at a top motor speed may be about 1,000 times greater than the output voltage of the magnetic sensor at low motor speeds. As such, the sensor signal may be much more susceptible to corruption due to noise at low motor speeds. Accordingly, some signal processing configurations may use diodes to clip the sensor signal at high amplitudes and filter the remaining signal such that low motor speeds may not be detected.

One aspect of the present disclosure is directed to a processing circuit for processing a sensor signal of a magnetic sensor to reduce sensor noise. The sensor output may be generally sinusoidal and have an amplitude that is proportional to a speed of the motor. As such, the processing circuit may over-filter the sensor signal such that some frequencies of interest (e.g., frequencies within a sensor frequency range associated with the magnetic sensor) are subject to attenuation. For instance, a corner frequency of a low pass filter of the processing circuit may be set within a sensor frequency range associated with the magnetic sensor. By shifting the filter corner frequency lower, the attenuation of high-frequency noise may be increased, providing a more robust signal that may be processed by downstream circuitry.

The processing circuit may include a difference amplifier, which may reject common-mode noise coupled to the magnetic sensor while a differential mode low-pass stage may attenuate differential-mode noise. A corner frequency of a first low-pass filter of the processing circuit may be set at a frequency based on a minimum desirable amplitude of the sensor signal. For instance, the corner frequency may be set such that the sensor signal voltage achieves a minimum desirable amplitude at some frequency level and is attenuated by the first low-pass filter at frequencies greater than the corner frequency. In some embodiments, the sensor signal amplitude may increase with frequency at a rate corresponding to the attenuation rate of the first low-pass filter. For instance, the sensor output amplitude may have a +20 dB/dec characteristic while the first low-pass filter may have a −20 dB/dec characteristic after the corner frequency.

In some embodiments, the processing circuit may further include an amplifier stage having a second low-pass filter. The second low-pass filter may have a corner frequency greater than the corner frequency of the first low-pass filter to further attenuate sensor signals with a frequency within a noise frequency range. For instance, the corner frequency of the second low-pass filter may be set above the sensor frequency range to further reduce noise voltage.

In some embodiments, the processing circuit may further include a Schmitt trigger circuit configured to provide a processed sensor signal as a square wave signal. A frequency of the square wave signal may be indicative of the speed of the rotor. The square wave signal may be provided to a controller to be used as, for instance, a feedback signal. For example, the controller may control an inverter associated with the motor based at least in part on the processed sensor signal.

Aspects of the present disclosure provide for multiple technical effects and benefits. For example, aspects of the present disclosure may provide for accurate detection of motor speed with cost-effective components. In addition, aspects of the present disclosure may provide for rotor speed detection at lower motor speeds, such as low motor speeds associated with a startup mode of an appliance.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (e.g., “A or B” is intended to mean “A or B or both”). The term “at least one of” in the context of, e.g., “at least one of A, B, and C” refers to only A, only B, only C, or any combination of A, B, and C. In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

The terms “coupled,” “fixed,” “attached to,” and the like refer to both direct coupling, fixing, or attaching, as well as indirect coupling, fixing, or attaching through one or more intermediate components or features, unless otherwise specified herein.

Except as explicitly indicated otherwise, recitation of a singular processing element (e.g., “a controller,” “a processor,” “a microprocessor,” etc.) is understood to include more than one processing element. In other words, “a processing element” is generally understood as “one or more processing element.” Furthermore, barring a specific statement to the contrary, any steps or functions recited as being performed by “the processing element” or “said processing element” are generally understood to be capable of being performed by “any one of the one or more processing elements.” Thus, a first step or function performed by “the processing element” may be performed by “any one of the one or more processing elements,” and a second step or function performed by “the processing element” may be performed by “any one of the one or more processing elements and not necessarily by the same one of the one or more processing elements by which the first step or function is performed.” Moreover, it is understood that recitation of “the processing element” or “said processing element” performing a plurality of steps or functions does not require that at least one discrete processing element be capable of performing each one of the plurality of steps or functions.

Referring now to the figures, example aspects of the present disclosure will be discussed in greater detail.

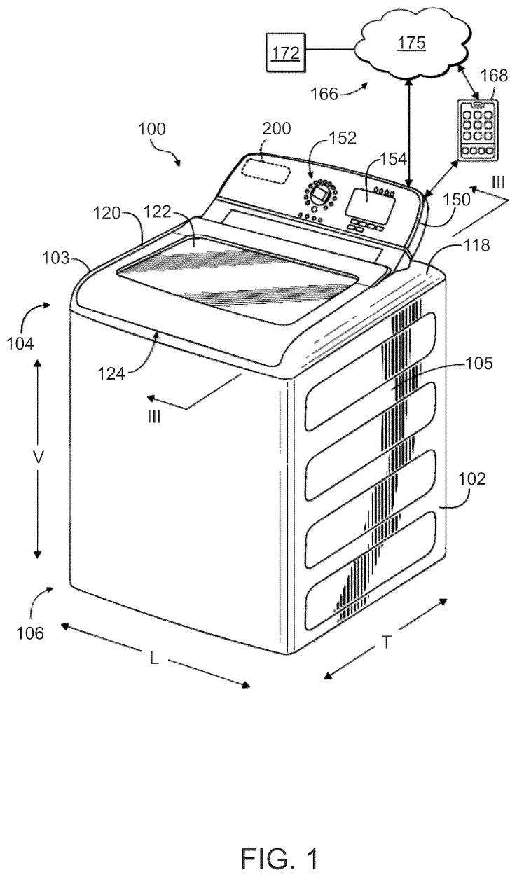

FIG. 1-3 illustrate an example appliance 100 according to example embodiments of the present disclosure. While appliance 100 is depicted in FIG. 1-3 as a laundry appliance (e.g., washing machine appliance), those of ordinary skill in the art will understand that aspects of the present disclosure may be implemented within any suitable appliance without deviating from the scope of the present disclosure.

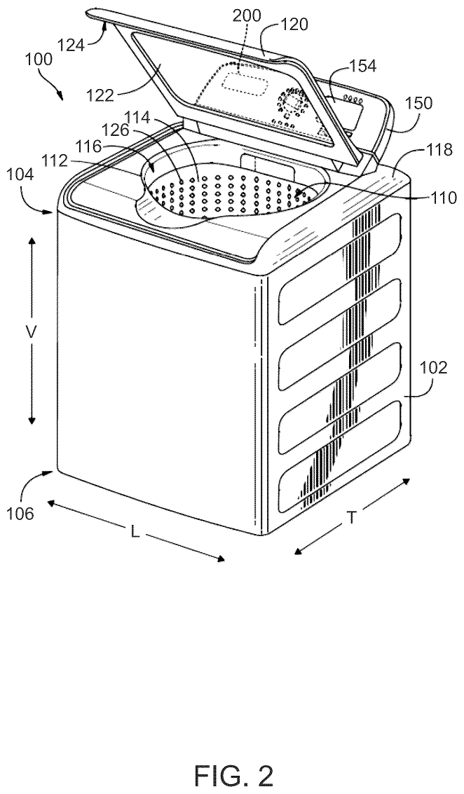

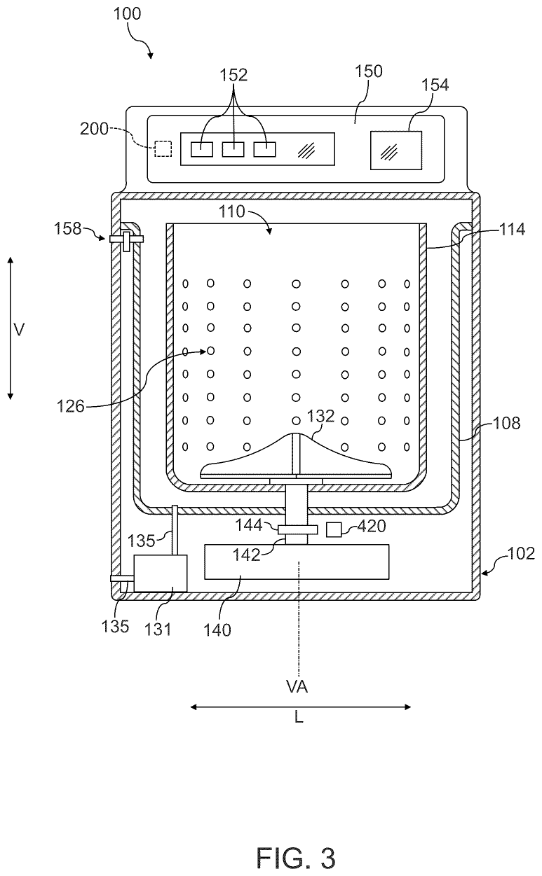

As shown in FIG. 1-3, washing machine appliance 100 generally defines a vertical direction V, a lateral direction L, and a transverse direction T, each of which is mutually perpendicular, such that an orthogonal coordinate system is generally defined. In FIG. 1, a lid or door 130 is shown in a closed position. In FIG. 2, door 130 is shown in an open position. Washing machine appliance 100 is depicted in FIG. 3 with an axis of rotation VA that is substantially parallel to the vertical direction V. In this regard, washing machine appliance 100 is generally referred to as a “vertical axis” or top loading washing machine appliance 100. However, it will be understood that aspects of the present disclosure may be used within the context of any suitable washing machine appliance, such as a horizontal axis or front loading washing machine appliance. Furthermore, one of ordinary skill in the art will understand that modifications and variations may be made to washing machine appliance 100 (e.g., vertical axis washing machine appliance 100), including different configurations, different appearances, or different features while remaining within the scope of the present disclosure.

As shown in FIGS. 1 through 3, washing machine appliance 100 is depicted with an axis of rotation VA that is substantially parallel to the vertical direction V. In this regard, washing machine appliance 100 is generally referred to as a “vertical axis” or top loading washing machine appliance 100. However, it will be understood that aspects of the present disclosure may be used within the context of any suitable washing machine appliance, such as a horizontal axis or front loading washing machine appliance. Furthermore, one of ordinary skill in the art will understand that modifications and variations may be made to washing machine appliance 100 (e.g., vertical axis washing machine appliance 100), including different configurations, different appearances, or different features while remaining within the scope of the present disclosure.

As shown in FIG. 1, washing machine appliance 100 includes a cabinet 102 that extends between a top portion 104 and a bottom portion 106 along the vertical direction V, between a first (left) side panel 103 and a second (right) side panel 105 along the lateral direction L, and between a front panel 107 and a rear panel 109 along the transverse direction T. As shown in FIG. 3, a wash tub 108 is positioned within cabinet 102, the wash tub 108 defining a wash chamber 110, and generally configured for retaining wash fluids during an operating cycle. As used herein, “wash fluid” means water, or water with additives (for example detergent, fabric softener, or bleach) used in any part of a laundry appliance operation or cycle. Without limitation, “wash fluid” includes fluid used in wash, rinse, or drain and spin cycles.

Further, washing machine appliance 100 includes a wash basket 114 positioned within wash tub 108 and generally defining an opening 116 for receipt of laundry articles for washing. Wash basket 114 is defined by a side wall 115 and a bottom wall 117 with side wall 115 and bottom wall 117 defining a wash chamber 110. Wash basket 114 is supported within wash tub 108 for rotation about an axis of rotation A. According to the illustrated embodiment, the axis of rotation A is substantially parallel to the vertical direction V and runs through the center of the wash tub 108 and wash basket 114. In this regard, washing machine appliance 100 is generally referred to as a “vertical axis” or top loading washing machine appliance 100.

As illustrated, cabinet 102 of washing machine appliance 100 has a top panel 118 which defines a top panel opening 112 (FIG. 2) that coincides with opening 116 of wash basket 114 to permit a user access to wash basket 114. Washing machine appliance 100 further includes a lid 120 which may be rotatably mounted to top panel 118 to permit selective access to wash basket 114 through opening 116. Lid 120 selectively rotates between the closed position (FIG. 1) and the open position (FIG. 2). In the closed position, lid 120 blocks access to wash basket 114. Conversely, in the open position, a user can access wash basket 114. A window 122 in lid 120 permits viewing of wash basket 114 when lid 120 is in the closed position, for example, during operation of washing machine appliance 100. Lid 120 may also include a handle 124 that may facilitate opening and closing lid 120. Further, although lid 120 is illustrated as mounted to top panel 118, lid 120 may alternatively be mounted to cabinet 102 or any other suitable support.

As illustrated in FIGS. 2 and 3, wash basket 114 may further define a plurality of perforations 126 formed in side wall 115 to facilitate fluid communication between an interior of wash basket 114 and wash tub 108. For at least this purpose, wash basket 114 is spaced apart from wash tub 108 to define a space for wash fluid to escape wash chamber 110. During a spin cycle, wash fluid within articles of clothing and within wash chamber 110 may be urged through perforations 126 and may collect in a sump 128 defined between the lower portions of wash basket 114 and wash tub 108. Washing machine appliance 100 may further include a drain pump 131 (FIG. 3) that is located beneath wash tub 108 and wash basket 114 for gravity assisted flow when draining wash tub 108. Drain pump 131 may be positioned along or in operative communication with a drain line 135 which provides fluid communication from the wash chamber 110 of the wash basket 114 to the external conduit, such as a wastewater line (not shown). In some embodiments, drain pump 131 may be operably coupled to control circuit 200 to, for instance, accept operating instructions (for example on or off commands or speed control) to drain wash fluid from wash tub 108 and provide feedback to the control circuit 200.

In some embodiments, an impeller or agitation element 132 (FIG. 3), such as a vane agitator, may be disposed in wash basket 114 to impart an oscillatory motion to laundry articles and liquid in wash basket 114. More specifically, agitation element 132 extends into wash basket 114 and assists agitation of articles disposed within wash basket 114 during operation of washing machine appliance 100 to, for example, facilitate improved cleaning. In different embodiments, agitation element 132 includes a single action element (i.e., oscillatory only), a double action element (oscillatory movement at one end, single direction rotation at the other end) or a triple action element (oscillatory movement plus single direction rotation at one end, single direction rotation at the other end). As illustrated in FIG. 3, agitation element 132 and wash basket 114 may be oriented to rotate about axis of rotation VA, which is substantially parallel to vertical direction V and centrally located in wash tub 108.

As illustrated in FIG. 3, washing machine appliance 100 includes a motor 140 in mechanical communication with (i.e., mechanically coupled to) wash basket 114 to, for instance, selectively rotate wash basket 114. In some embodiments, motor 140 may also be in mechanical communication with agitation element 132. In this manner, motor 140 may be configured for selectively rotating or oscillating wash basket 114 and/or agitation element 132 during various operating cycles of washing machine appliance 100.

Motor 140 may be an inverter driven motor. For instance, motor 140 may be an induction motor, such as a controlled induction motor (CIM). Motor 140 may alternatively be a brushless direct current (BLDC) motor, a switched reluctance motor, a permanent magnet synchronous motor (PMSM), or any other suitable type of motor. In addition, motor 140 may include any other suitable number, types, and configurations of support bearings or drive mechanisms. Generally, the motor 140 is fixed to the wash tub 108 with appropriate sealing elements (not shown) to achieve a watertight seal to contain wash fluid in the wash tub 108.

Motor 140 may be mechanically coupled to wash basket 114 and/or agitation element 132 via a rotor shaft 142. As rotor shaft 142 is rotated, wash basket 114 and/or agitation element 132 may be driven by motor 140. As shown in FIG. 3, rotor shaft 142 may include a rotor component 144 that may rotate with rotor shaft 142. For instance, rotor component 144 may be a gear or sprocket coupled to the rotor shaft 142. Appliance 100 may further include a magnetic sensor 420 (e.g., magnetic pickup sensor) positioned proximate to the rotor shaft 142 (e.g., rotor component 144 of rotor shaft 142). Magnetic sensor 420 may be configured to detect a speed of the motor 140 (e.g., rotational speed of rotor shaft 142 of motor 140). For instance, as the rotor component 144 is rotated, the magnetic permeability of the space near the magnetic sensor 420 may change as portions of the rotor component 144 rotate into and out of the sensed area. Based on this change in magnetic permeability, magnetic sensor 420 may provide a sensor signal corresponding to the rotor speed of the motor 140. In some embodiments, rotor shaft 142 may be coupled via a belt and pulley to wash basket 114. The wash basket 114 may be geared down to produce more torque while rotating at a lower speed than shaft 142. As such, motor speed may be determined based on the rotational speed of the wash basket 114. For instance, magnetic sensor 420 may be configured to sense the speed of the rotor shaft 142 or the rotational speed of the wash basket 114. In some embodiments, motor 140 may be a direct driven motor, such as a permanent magnet synchronous motor (PMSM). Accordingly, the rotor shaft 142 may be attached to the wash basket 114 while the stator of the motor 140 may be attached to the tub 108.

Referring still to FIGS. 1 through 3, washing machine appliance 100 further includes a control panel 150. As shown, control panel 150 may extend from top panel 118 of washing machine appliance 100. Control panel 150 may include one or more input selector 152 (e.g., a user interface input) for operator selection of machine cycles and features. A display 154 of control panel 150 may indicate selected features, operation mode, a countdown timer, and/or other items of interest to appliance users regarding operation.

Control panel 150 further includes control circuit 200. Operation of washing machine appliance 100 is controlled by control circuit 200 that is operatively coupled (e.g., electrically coupled or connected) to at least one user input selector 152 located on control panel 150 (FIG. 1) for user manipulation to select washing machine cycles and features. Control panel 150 and input selector 152 collectively form a user interface input for operator selection of machine cycles and features. In response to user manipulation of the user input selector 152, control circuit 200 operates the various components of washing machine appliance 100 to execute selected machine cycles and features. A display 154 on control panel 150 may indicate selected features, operation mode, a countdown timer, and/or other items of interest to appliance users regarding operation. In addition to the visual display 154, control panel 150 may also include auditory signaling devices, such as a speaker.

Washing machine appliance 100 may receive power from a power supply, such as an residential power outlet or other power source. For example, the power supply may provide conventional 60 Hz, 120-volt or 240-volt AC to washing machine appliance 100.

The control circuit 200 may be operably coupled to a wash fluid supply assembly 158 to supply wash fluid to the wash tub 108. Wash fluid supply assembly 158 may receive water from a water supply (not shown), such as a municipal water source. The wash fluid supply assembly 158 may include a valve and associated piping. The valve may be operably coupled to the control circuit 200 to open and close as needed to supply wash water to the wash tub 108. The wash fluid supply assembly 158 may also be fluidly coupled to dispensers (not shown) for detergent, bleach, or other water treatments that may be combined with the supplied water to produce a wash fluid. The dispensers maty be operably coupled to the control circuit 200 to selectively introduce water treatments to the water in producing wash fluid.

Components of washing machine appliance 100 may be in operative communication with control circuit 200 via one or more signal lines or shared communication busses to provide signals to and/or receive signals from the control circuit 200. For example, the control circuit 200 may communicate with the motor 140 to, for instance, selectively rotate the wash basket 114 at various speeds or directions of rotation.

In some embodiments, washing machine appliance 100 may include an external communication system 166. Referring back to FIG. 1, a schematic illustration of an external communication system 166 will be described according to an example embodiment of the present subject matter. In general, external communication system 166 is configured for permitting interaction, data transfer, and other communications between washing machine appliance 100 and one or more external devices. For example, this communication may be used to provide and receive operating parameters, user instructions or notifications, performance characteristics, user preferences, or any other suitable information for improved performance of washing machine appliance 100. In addition, it should be appreciated that external communication system 166 may be used to transfer data or other information to improve performance of one or more external devices or appliances and/or improve user interaction with such devices.

For example, external communication system 166 may permit control circuit 200 of washing machine appliance 100 to communicate with a separate device external to washing machine appliance 100, referred to generally herein as an external device 168. As described in more detail below, these communications may be facilitated using a wired or wireless connection, such as via a network 175. In general, external device 168 may be any suitable device separate from washing machine appliance 100 that is configured to provide and/or receive communications, information, data, or commands from a user. In this regard, external device 168 may be, for example, a personal phone, a smartphone, a tablet, a laptop or personal computer, a wearable device, a smart home system, or another mobile or remote device.

In addition, a remote server 172 may be in communication with washing machine appliance 100 and/or external device 168 through network 175. In this regard, for example, remote server 172 may be a cloud-based server, and is thus located at a distant location, such as in a separate state, country, etc. According to an example embodiment, external device 168 may communicate with a remote server 172 over network 175, such as the Internet, to transmit/receive data or information, provide user inputs, receive user notifications or instructions, interact with or control washing machine appliance 100, etc. In addition, external device 168 and remote server 172 may communicate with washing machine appliance 100 to communicate similar information.

In general, communication between washing machine appliance 100, external device 168, remote server 172, and/or other user devices or appliances may be carried using any type of wired or wireless connection and using any suitable type of communication network, non-limiting examples of which are provided below. For example, external device 168 may be in direct or indirect communication with washing machine appliance 100 through any suitable wired or wireless communication connections or interfaces, such as network 175. For example, network 175 may include one or more of a local area network (LAN), a wide area network (WAN), a personal area network (PAN), the Internet, a cellular network, any other suitable short-or long-range wireless networks, etc. In addition, communications may be transmitted using any suitable communications devices or protocols, such as via Wi-Fi®, Bluetooth®, Zigbee®, wireless radio, laser, infrared, Ethernet type devices and interfaces, etc. In addition, such communication may use a variety of communication protocols (e.g., TCP/IP, HTTP, SMTP, FTP), encodings or formats (e.g., HTML, XML), and/or protection schemes (e.g., VPN, secure HTTP, SSL).

External communication system 166 is described herein according to an example embodiment of the present subject matter. However, it should be appreciated that the example functions and configurations of external communication system 166 provided herein are used only as examples to facilitate description of aspects of the present subject matter. System configurations may vary, other communication devices may be used to communicate directly or indirectly with one or more associated appliances, other communication protocols and steps may be implemented, etc. These variations and modifications are contemplated as within the scope of the present subject matter.

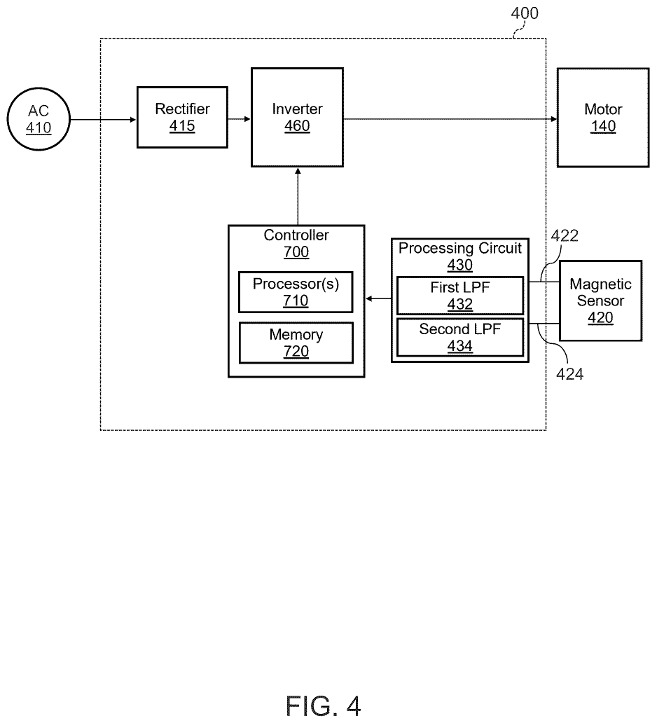

Referring now to FIG. 4, a block diagram of an example motor drive circuit 400 is provided according to example embodiments of the present disclosure. As shown, motor drive circuit 400 may be configured to control (e.g., drive) a motor 140 using power provided from an AC supply 410. Motor drive circuit 400 may be implemented within an appliance, such as washing machine appliance 100 of FIG. 1.

As illustrated in FIG. 4 motor drive circuit 400 may be configured to receive power from an AC supply 410 which may provide conventional 60 Hz, 120-volt or 240-volt AC. For example, the AC supply 410 may be a residential power outlet or other power source.

Motor drive circuit 400 may include a rectifier circuit 415 which may be connected in series and operate to rectify the voltage signal of the AC supply 410. The rectifier circuit 415 may be configured to output a DC voltage to an inverter 460. In some embodiments, rectifier circuit 415 may further include line filter circuitry and/or power factor correction (PFC) circuitry to further process the voltage signal of the AC supply 410.

Motor drive circuit 400 further includes an inverter 460 configured to provide power to motor 140. Inverter 460 may convert the output voltage from the rectifier 415 to power to be supplied to motor 140. A switching frequency of inverter 460 may correspond to a desired speed of the motor 140. For instance, the inverter 460 may include one or more switching components to control the flow of power to motor 140. The rate at which these switching components turn on and off (e.g., switching frequency) may be controlled to set a desired speed of the motor 140.

Motor drive circuit 400 may be coupled to a magnetic sensor 420 (e.g., magnetic pickup sensor) configured to provide a sensor signal indicative of a speed of a rotor of the motor. Specifically, the sensor signal may have a frequency that is a multiple of the frequency at which the motor rotates. For instance, as shown in FIG. 1, magnetic sensor 420 may be an off-board sensor positioned proximate a rotor shaft 142 (e.g., rotor component 144 of rotor shaft 142) of motor 140 such that the magnetic sensor 420 may provide a sensor signal indicative of the rotational speed of the rotor shaft 142 based on a change in the magnetic permeability of the space near the magnetic sensor 420.

Motor drive circuit 400 further includes a processing circuit 430. As shown in FIG. 4, processing circuit 430 may be coupled to magnetic sensor 420 via a pair of lead lines 422, 424. The magnetic sensor 420 may provide the sensor signal to the processing circuit 430 via lead lines 422, 424. For example, a first lead line 422 may provide a positive sensor input and a second lead line 424 may provide a negative sensor input such that the sensor signal may be a floating signal provided by the voltage across the pair of lead lines 422, 424.

Processing circuit 430 is configured to process the sensor signal to provide an appropriately conditioned processed sensor signal for a controller (e.g., microcontroller) or similar device to utilize. For instance, processing circuit 430 may include one or more filtering circuits, such as low pass filtering circuits 432, 434 to filter the sensor signal to, for instance, reduce the noise (e.g., common-mode noise and/or differential mode noise) of the sensor signal.

As shown in FIG. 4, processing circuit 430 may include a first low pass filtering circuit 432 (e.g., first LPF 432). First low pass filtering circuit 432 is configured to attenuate a sensor signal provided by the magnetic sensor 420 when a frequency of the sensor signal is greater than a first corner frequency (e.g., cut-off frequency) of the first low pass filtering circuit 432. The first corner frequency may be set within a sensor frequency range associated with the magnetic sensor. For instance, sensor signals having a frequency within the sensor frequency range may be valid sensor signals indicating a speed of the motor 140. Accordingly, the first low pass filtering circuit 432 of processing circuit 430 may have a first corner frequency set within the sensor frequency range such that at least some sensor signals with a frequency within the sensor frequency range are attenuated by the first low pass filtering circuit 432.

In some embodiments, processing circuit 430 may further include a second low pass filtering circuit 434 (e.g., second LPF 434). Second low pass filtering circuit 434 is configured to attenuate a sensor signal provided by the magnetic sensor 420 when a frequency of the sensor signal is greater than a second corner frequency (e.g., cut-off frequency) of the second low pass filtering circuit 434.

Controller 700 may be configured to control inverter 460. For example, controller 700 may control the switching frequency of inverter 460 based on a desired speed of the motor 140. Controller 700 may include one or more processor(s) 710. Processor(s) 710 may include any suitable processing device(s), such as one or more of a general or special purpose microprocessor, a microcontroller, an integrated circuit, an application specific integrated circuit (ASIC), a digital signal processor (DSP), a field-programmable gate array (FPGA), a logic device, one or more central processing units (CPUs), a graphics processing units (GPUs), processing units performing other specialized calculations, semiconductor devices, etc. In addition, processor(s) 710 are not necessarily restricted to a single element but may include any suitable number, type, and configuration of processing devices integrated in any suitable manner to facilitate appliance operation. In alternative embodiments, controller 700 may be constructed without using a microprocessor, e.g., using a combination of discrete analog or digital logic circuitry (such as switches, amplifiers, integrators, comparators, flip-flops, OR gates, and the like) to perform control functionality instead of relying upon software.

Controller 700 may further include, or be associated with, one or more memory devices 720. Memory devices 720 may include one or more memory elements or non-transitory computer-readable storage mediums, such as RAM, ROM, EEPROM, EPROM, flash memory devices, magnetic disks, or other suitable memory devices (including combinations thereof). Memory devices 720 may be a separate component from the processor(s) 710 or may be included onboard within the processor(s) 710. In addition, memory devices 720 can store information or data accessible by the one or more processors 710, including instructions that can be executed by the one or more processors 710. It should be appreciated that the instructions can be software written in any suitable programming language or can be implemented in hardware. Additionally, or alternatively, the instructions can be executed logically or virtually using separate threads on the one or more processors 710.

For example, controller 700 may be operable to execute programming instructions or micro-control code associated with an operating mode of an appliance, such as appliance 100 (FIG. 1). In this regard, the instructions may be software or any set of instructions that when executed by the one or more processor(s) 710, cause the one or more processor(s) 710 to perform operations, such as running one or more software applications, displaying a user interface, receiving user input, processing user input, etc.

In some embodiments, memory devices 720 may also store data that can be retrieved, manipulated, created, or stored by the one or more processors 710 of controller 700. The data can be stored locally (e.g., on controller 700) in one or more databases or may be split up so that the data is stored in multiple locations. In addition, or alternatively, one or more database(s) can be connected to controller 700 through any suitable network(s), such as through a high bandwidth local area network (LAN) or wide area network (WAN). In this regard, for example, controller 700 may further include a communication interface that may be used to communicate with one or more other component(s) of, for instance, an appliance such as appliance 100 (FIG. 1). Additionally and/or alternatively, controller 700 can include any suitable components for interfacing with one or more network(s), including for example, transmitters, receivers, ports, controllers, antennas, or other suitable components.

In some embodiments, controller 700 may be configured to control the inverter 460 based at least in part on the processed sensor signal provided by the processing circuit 430. For instance, the processed sensor signal may be provided to controller 700 as a square wave signal having a frequency indicative of an actual speed of the motor 140 (e.g., rotor of the motor 140). Specifically, the frequency of the processed sensor signal may be some multiple of the frequency (e.g., rotational speed) of the motor. For instance, controller 700 may multiply/divide the frequency of the processed sensor signal by a constant to determine the motor speed corresponding to the processed sensor signal. As such, the processed sensor signal may be used as a feedback signal to further adjust the power provided to the motor 140. For instance, controller 700 may adjust the switching frequency or pulse width modulated (PWM) output frequency of the inverter 460 to correspond to a desired speed of the motor 140.

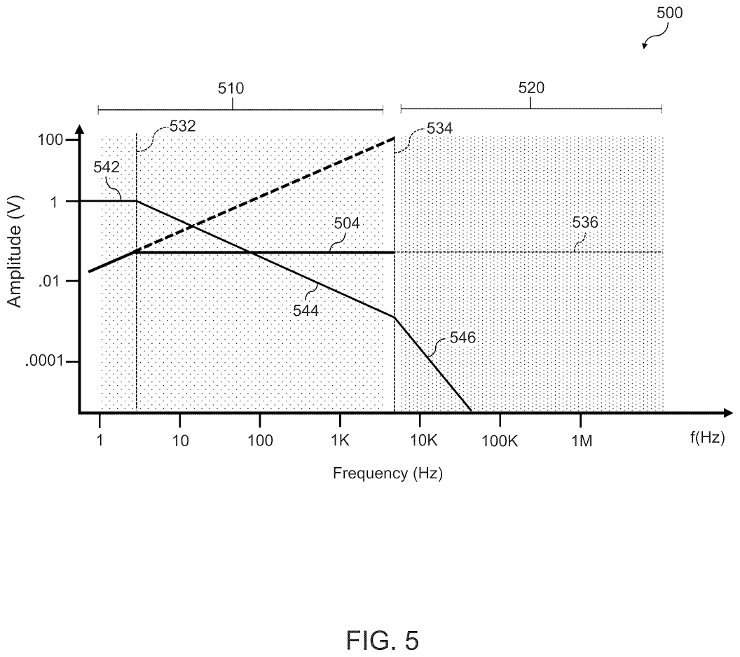

FIG. 5 provides a plot 500 depicting an example filtering scheme of a processing circuit 430 according to example embodiments of the present disclosure. Magnetic sensor 420 (FIG. 4) may have an amplitude characteristic dependent on frequency. For instance, an example sensor signal 502 (e.g., unattenuated sensor signal) provided by a magnetic sensor 420 (FIG. 4) is shown in FIG. 5 over various frequencies. As shown, the amplitude of the sensor signal 502 may increase as the frequency of the signal increases, such as by a +20 dB/dec amplitude characteristic. Plot 500 also provides an example processed sensor signal 504 provided by a processing circuit 430 (FIG. 4) based on the example sensor signal 502 at the corresponding frequency.

As previously described with reference to FIG. 4, processing circuit 430 may include a first low pass filtering circuit 432 having a first corner frequency 532 and a second low pass filtering circuit 434 having a second corner frequency 534. As such, plot 500 of FIG. 5 provides an example first corner frequency 532 of a first low pass filtering circuit 432 (FIG. 4) and an example second corner frequency 534 of a second low pass filtering circuit 434 (FIG. 4).

As shown in plot 500, the first corner frequency 532 may be set within a sensor frequency range 510 associated with the magnetic sensor 420 (FIG. 4). For instance, as shown in FIG. 5, the sensor frequency range 510 may include frequencies from about 1 hertz (Hz) to about 2000 Hz. The sensor frequency range 510 may correspond to a speed range of the motor 140. As such, processing circuit 430 may process the sensor signal 502 to provide a processed sensor signal indicating a speed of motor 140 (FIG. 4, FIG. 5) for sensor signals having a frequency within the sensor frequency range 510. Specifically, the frequency of the sensor signal may be some multiple of the frequency (e.g., rotational speed) of the motor. For example, a controller, such as controller 700 (FIG. 4), may multiply/divide the frequency of the sensor signal by a constant to determine the motor speed corresponding to the sensor signal. In some embodiments, the motor 140 (FIG. 4, FIG. 5) may have a maximum speed corresponding to a sensor signal frequency of about 2000 Hz. Accordingly, processing circuit 430 may be configured to process sensor signal 502 at any sensor signal frequency less than about 2000 Hz.

Line segment 542 indicates the filter transfer function of processing circuit 430 at frequencies less than the first corner frequency 532. A sensor signal 502 with a frequency less than the first corner frequency 532 may not be attenuated by the first low pass filter 432. For instance, as shown, the amplitude of the sensor signal 502 may be the same as the amplitude of the processed sensor signal 504 at frequencies less than the first corner frequency 532.

Line segment 544 indicates the filter transfer function of processing circuit 430 at frequencies greater than the first corner frequency 532 and less than the second corner frequency 534. As shown, a sensor signal 502 with a frequency greater than the first corner frequency 532 and less than the second corner frequency 534 may be attenuated by the first low pass filter circuit 432 to provide a processed sensor signal 504. For instance, as shown in plot 500, the amplitude of sensor signal 502 may increase based on the amplitude characteristic of the sensor signal 502. At frequencies higher than the first corner frequency 532 and less than the second corner frequency 534, the sensor signal 502 is attenuated by the first low pass filtering circuit 432 to provide the processed sensor signal 504. As shown, the first low pass filtering circuit 432 may attenuate the sensor signal 502 at a rate proportional to the amplitude characteristic of the sensor signal 502. For instance, if the amplitude of the sensor signal 502 has a +20 dB/dec characteristic, the first low pass filtering circuit 432 may have a −20 dB/dec characteristic after the first corner frequency 532. As such, line segment 544 indicating the filter transfer function of processing circuit 430 may have a negative slope that corresponds in magnitude to the positive slope of the sensor signal 502. Accordingly, the sensor signal 502 may be attenuated such that the amplitude of the processed sensor signal 504 is generally constant between the first corner frequency 532 and the second corner frequency 534.

In some embodiments, the corner frequency 532 of the first low pass filtering circuit 432 may be set such that the amplitude of the sensor signal 502 is attenuated to a minimum desirable amplitude 536 at frequencies between the first corner frequency 532 and the second corner frequency 534. As shown, the minimum desirable amplitude 536 may correspond to the amplitude of the sensor signal 602 at the corner frequency 532 of the first low pass filtering circuit 432.

Line segment 546 indicates the filter transfer function of processing circuit 430 at frequencies greater than the second corner frequency 534 (e.g., greater than the first corner frequency 532 and the second corner frequency 534). The second corner frequency 534 may be set at a frequency greater than the sensor frequency range 510 such that a sensor signal at frequencies within a noise frequency range 520 may be attenuated by both the first low pass filtering circuit 432 and the second low pass filtering circuit 434. As shown, a sensor signal 502 with a frequency greater than the second corner frequency 534 may be attenuated by both the first low pass filtering circuit 432 and the second low pass filtering circuit 434 such that the processing circuit 430 may not provide a processed sensor signal 504 at frequencies within the noise frequency range 520.

In some embodiments, the noise frequency region 520 may be associated with noise provided by an inverter, such as inverter 460 (FIG. 4). For instance, the inverter may produce noise associated with the switching frequency of the inverter. As such, the noise frequency region 520 may correspond to the switching frequency of the inverter.

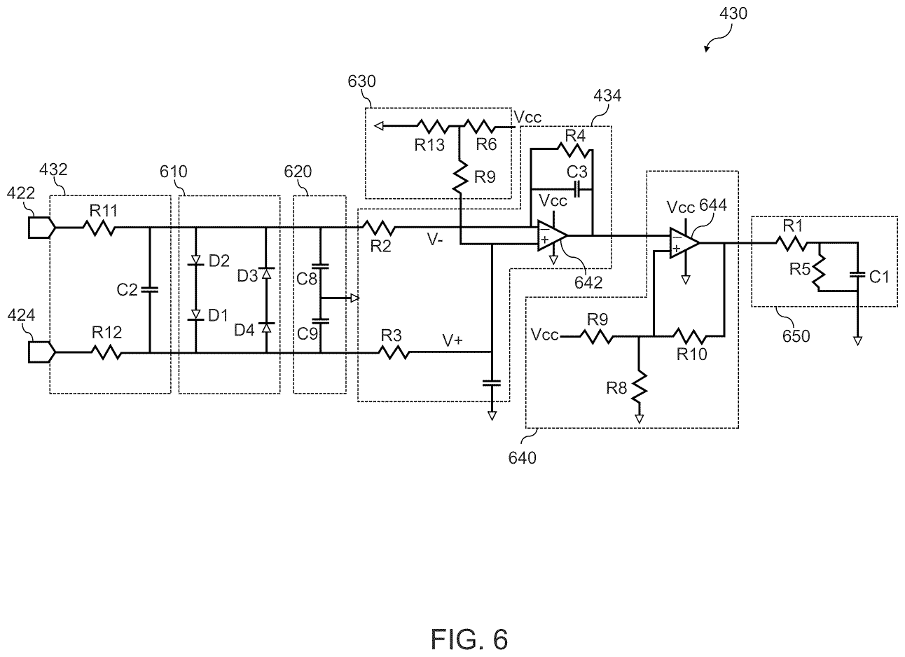

Referring now to FIG. 6, a circuit schematic of an example processing circuit 430 is provided. Processing circuit 430 may receive a sensor signal from a magnetic sensor (e.g., magnetic pickup sensor) such as magnetic sensor 420 (FIGS. 3 and 4) via lead lines 422, 424. For instance, lead line 422 may provide a positive sensor input while lead line 424 may provide a negative sensor input such that the sensor signal may be a floating signal provided by the voltage across the pair of lead lines 422, 424.

Processing circuit 430 includes a first low pass filtering circuit 432 configured to attenuate a sensor signal. As shown, first low pass filtering circuit 432 may be an RC low pass filter having, for instance, two resistors (R11 and R12) and a capacitor (C2). While first low pass filtering circuit 432 is depicted in FIG. 6 as an RC low pass filtering circuit, those of ordinary skill in the art will understand that other configurations and/or types of low pass filtering circuits may be used without deviating from the scope of the present disclosure.

In some embodiments, processing circuit 430 may further include a diode protection circuit 610 to, for example, limit the amplitude of a processed sensor signal. Diode protection circuit 610 may be coupled to the first low pass filtering circuit 432. As shown, diode protection circuit 610 may include four diodes (D1, D2, D3, D4).

In some embodiments, processing circuit 430 may further include a common-mode noise filtering circuit 620. Common-mode noise filtering circuit 620 may be coupled to the diode protection circuit 610 and may filter the sensor signal to reduce common-mode noise. As shown, common-mode filtering circuit 620 may include two capacitors (C7 and C8).

Processing circuit 432 may further include a second low pass filtering circuit 434. Second low pass filtering circuit 434 may be an active low pass filtering circuit having an amplifier 642. A positive input of amplifier 642 may be coupled to lead line 424 via the first low pass filtering circuit 432, diode protection circuit 610, and common-mode noise filtering circuit 620. In some embodiments, a mid-rail offset circuit 630 may also be coupled to the positive input of amplifier 642. The mid-rail offset circuit 630 may couple the negative input of amplifier 642 to a common voltage supply (Vcc) via a resistor network (e.g., resistors R6, R13, and R9). For instance, mid-rail offset circuit 630 may provide a voltage offset to the positive input of amplifier 642 to bias the amplifier circuit appropriately.

The negative input of amplifier 642 may be coupled to lead line 422 via the first low pass filtering circuit 432, diode protection circuit 610, and common-mode noise filtering circuit 620. Second low pass filtering circuit 434 may also include feedback circuitry (resistor R4 and capacitor C3) coupling the output of amplifier 642 back to the negative input of amplifier 642. While second low pass filtering circuit 434 is depicted in FIG. 6 as an active low pass filtering circuit incorporated within a difference amplifier circuit, those of ordinary skill in the art will understand that other configurations and/or types of low pass filtering circuits may be used without deviating from the scope of the present disclosure.

Processing circuit 432 may further include a Schmitt Trigger circuit 640. As shown, Schmitt trigger circuit 640 may be coupled to the second low pass filtering circuit 434 (e.g., output of amplifier 642 of second low pass filtering circuit 434). The output signal of amplifier 642 may be a generally sinusoidal signal. As such, Schmitt trigger circuit 640 may be configured to provide a square wave signal based on the output signal of amplifier 642.

As shown, the Schmitt trigger circuit 640 may include an amplifier 644. A negative input of amplifier 644 may be coupled to the output of amplifier 642, while a positive input of amplifier 644 may be coupled to a common voltage supply (Vcc), signal ground, and the amplifier 642 output via a resistor network (e.g., resistors R8, R9, and R10). The output of Schmitt trigger circuit 640 (e.g., output of amplifier 644 of Schmitt trigger circuit 640) may be a square wave signal having a frequency indicative of a speed of the motor.

In some embodiments, the output of the Schmitt trigger circuit 640 may be provided to an additional filtering circuit 650. The additional filtering circuit 650 may be coupled to a controller, such as controller 700 (FIG. 4). Filtering circuit 650 may be a RC circuit having resistors R1 and R5 and a capacitor C1. Filtering circuit 650 may be configured to filter any additional noise applied to a signal by processing circuit 430. As such, the processing circuit 430 (e.g., additional filtering circuit 650 of processing circuit 430) may provide the processed sensor signal to controller 700 (FIG. 4).

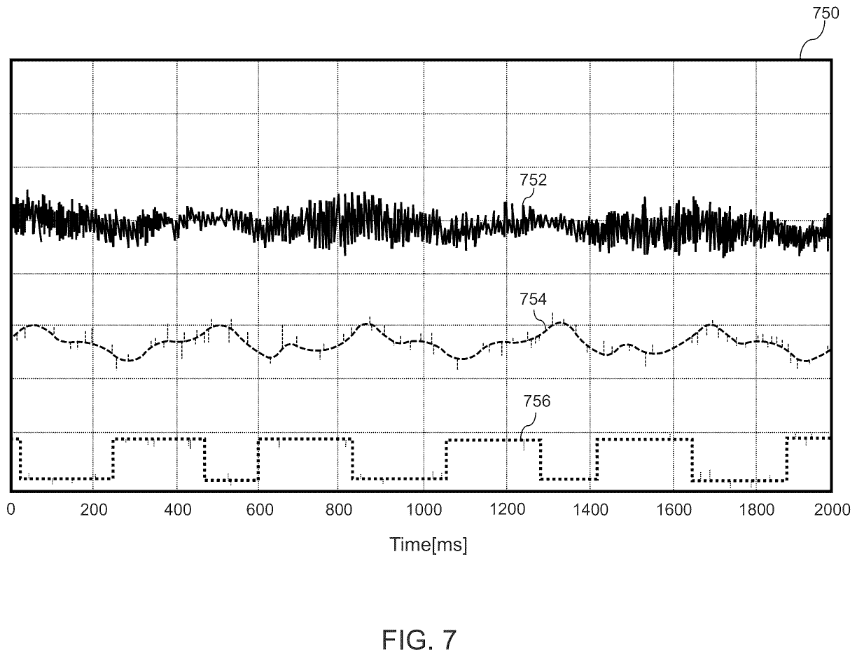

Referring now to FIG. 7, a graphical representation of example signals of processing circuit 430 is provided. Specifically, plot 750 of FIG. 7 provides example signals (e.g., example voltage signals) of processing circuit 430 over an example time period (e.g., the same example time period). Plot 750 depicts an example sensor signal 752 provided by a magnetic sensor, such as magnetic sensor 420 (FIGS. 3, 4). The example sensor signal 752 may have a frequency of about 2.5 Hz, indicating a motor speed of a motor of an appliance, such as motor 140 of appliance 100 (FIG. 1). The frequency of the example sensor signal 752 may directly correlate to (e.g., be a multiple of) the rotational speed of the motor. For instance, as shown in plot 750, example sensor signal 752 may have a frequency of about 2.5 Hz. The frequency of example sensor signal 752 (e.g., 2.5 Hz) may be divided/multiplied by a known constant to yield the corresponding motor speed. As shown, noise may be associated with the sensor signal 752 at this frequency (e.g., 2.5 Hz).

As such, the sensor signal 752 may be processed by the processing circuit 430 to yield output signal 754. Specifically, output signal 754 may be the output of amplifier 642 (FIG. 6) of processing circuit 430. As shown, output signal 754 may be a generally sinusoidal signal indicative of the motor speed.

As described with reference to FIG. 6, the output signal 754 of amplifier 642 may be provided to a Schmitt trigger circuit 640. The Schmitt trigger circuit 640 may provide a processed sensor signal, such as example square wave signal 756 shown in plot 750 of FIG. 7. As shown in FIG. 7, the frequency of example square wave signal 756 may indicate the speed of the motor (e.g., 2.5 Hz).

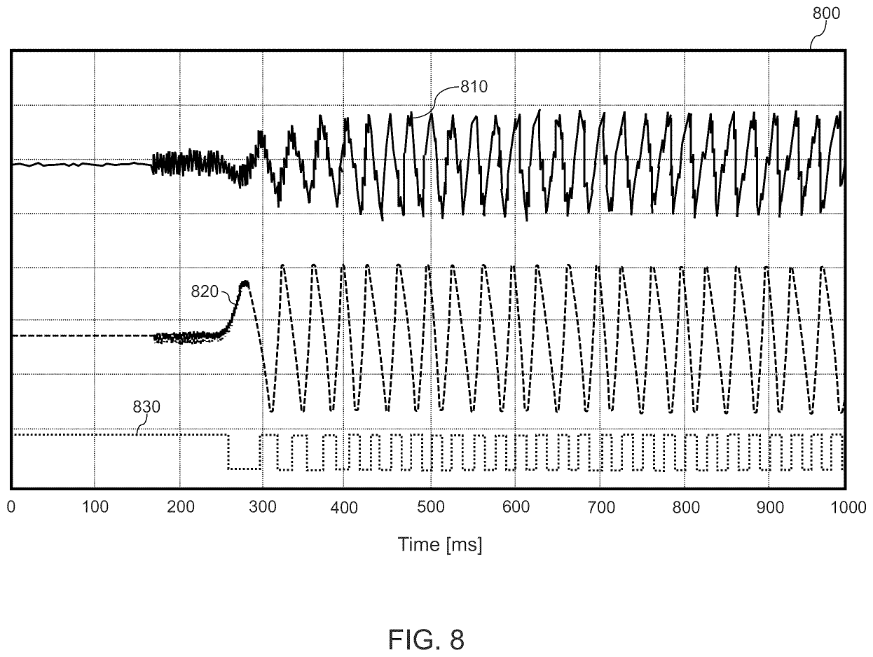

FIG. 8 provides a graphical representation of example signals of an example motor drive circuit according to example embodiments of the present disclosure during a startup mode of an appliance. Specifically, plot 800 of FIG. 8 provides example signals (e.g., example voltage signals) of motor drive circuit 400 (FIG. 4) over an example time period (e.g., the same example time period). Plot 800 depicts an example sensor signal 752 provided by a magnetic sensor, such as magnetic sensor 420 (FIG. 4) during a startup mode of an appliance, such as appliance 100 (FIG. 1-3). For example, a motor of the appliance, such as motor 140 may be started during a startup mode of the appliance.

As shown in FIG. 8, the example sensor signal 810 may increase in frequency as the motor starts up (e.g., increases in frequency). Plot 800 further includes an example output signal 820, which may be an output of amplifier 642 (FIG. 6) of processing circuit 430 and an example processed sensor signal 830, which may be a square wave signal that indicates the speed of the motor. Processing circuit 430 may provide for motor speed detection during a startup mode of an appliance, such as appliance 100 of FIG. 1. As shown in plot 800, the startup mode may be associated with low motor speeds, such as motor speeds corresponding to a sensor signal frequency of 0 Hz to about 40 Hz. As shown, the processed sensor signal 830 may be provided during the startup mode, such that motor speed detection may be provided at the low motor speeds associated with the startup mode of the appliance.

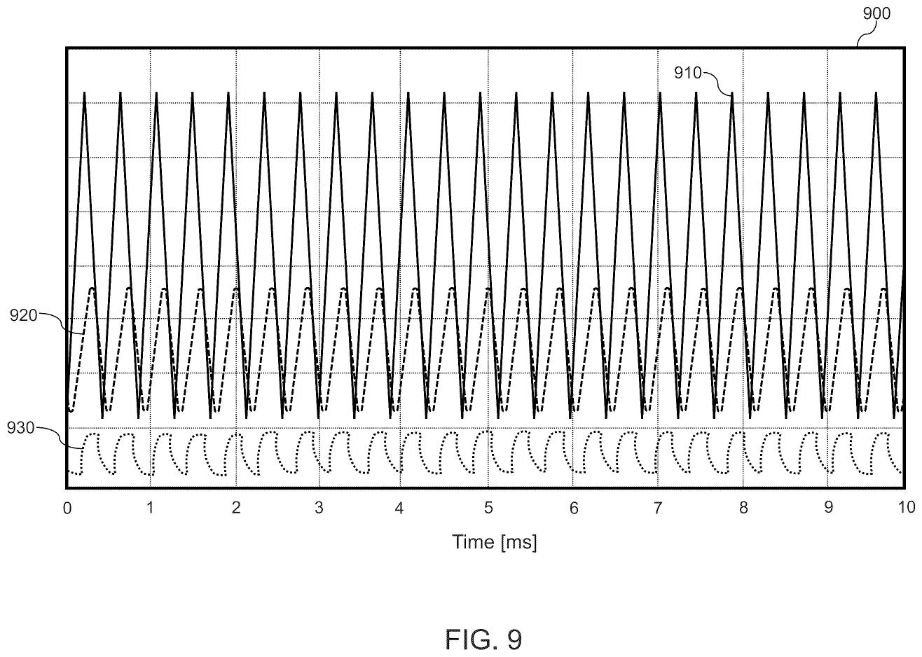

FIG. 9 provides a graphical representation of example signals of an example motor drive circuit according to example embodiments of the present disclosure during a top speed mode of an appliance. Specifically, plot 800 of FIG. 8 provides example signals (e.g., example voltage signals) of motor drive circuit 400 (FIG. 4) over an example time period (e.g., the same example time period). Plot 900 depicts an example sensor signal 910 provided by a magnetic sensor, such as magnetic sensor 420 (FIG. 4) during a top speed mode of an appliance, such as appliance 100 (FIG. 1-3). For example, a motor of the appliance, such as motor 140 may be operating at a top speed during the top speed mode of the appliance. As shown in FIG. 9, a top speed mode of the appliance may be at a motor speed corresponding to a sensor signal frequency of example sensor signal 910, such as a sensor signal frequency of about 2000 Hz. As shown, example sensor signal 910 of plot 900 may have a much greater amplitude and/or frequency when compared to example sensor signal 810 (FIG. 8) provided during a startup mode of the appliance.

Plot 900 further includes an example output signal 920, which may be an output of amplifier 642 (FIG. 6) of processing circuit 430 and an example processed sensor signal 930, which may be a square wave signal that indicates the speed of the motor. As shown, processing circuit 430 may provide for motor speed detection during a top speed mode of an appliance, such as appliance 100 of FIG. 1.

As shown in FIGS. 8 and 9, processing circuit 430 may provide for motor speed detection during a startup mode of an appliance associated with low motor speeds as well as during a top speed mode of an appliance associated with a top speed of a motor.

One example aspect of the present disclosure is directed to a motor drive circuit for controlling a motor in an appliance. The motor drive circuit includes an inverter configured to provide power to the motor. The motor drive circuit further includes a controller configured to control the inverter. The motor drive circuit further includes a processing circuit coupled to a magnetic sensor configured to provide a sensor signal indicative of a speed of the motor, the processing circuit configured to process the sensor signal to provide a processed sensor signal. The processing circuit includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

In some examples, the second corner frequency is set such that both the first low pass filter and the second low pass filter are configured to attenuate the sensor signal when the frequency of the sensor signal is within a noise frequency range.

In some examples, the noise frequency range is associated with noise provided by the inverter.

In some examples, the processing circuit is configured to provide the processed sensor signal to the controller, the controller configured to control the inverter based at least in part on the processed sensor signal.

In some examples, the processing circuit is configured to provide the processed sensor signal to the controller as a square wave signal, a frequency of the square wave signal indicative of the speed of the motor.

In some examples, the appliance is a washing machine appliance.

In some examples, the processing circuit is configured to process the sensor signal during a startup mode of the appliance.

Another example aspect of the present disclosure is directed to a processing circuit for processing a sensor signal indicative of a speed of a motor provided by a magnetic sensor in an appliance, the processing circuit configured to process the sensor signal to provide a processed sensor signal. The processing circuit includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

In some examples, the second corner frequency is set such that both the first low pass filter and the second low pass filter are configured to attenuate the sensor signal when the frequency of the sensor signal is within a noise frequency range.

In some examples, the noise frequency range is associated with noise provided by an inverter of the appliance configured to provide power to the motor.

In some examples, the processing circuit is configured to provide the processed sensor signal to a controller of the appliance, the controller configured to control the inverter based at least in part on the processed sensor signal.

In some examples, the processing circuit is configured to provide the processed sensor signal to the controller as a square wave signal, a frequency of the square wave signal indicative of the speed of the motor.

In some examples, the appliance is a washing machine appliance.

In some examples, the processing circuit is configured to process the sensor signal during a startup mode of the appliance.

Another example aspect of the present disclosure is directed to a washing machine appliance. The washing machine appliance includes a motor. The washing machine appliance further includes a magnetic sensor configured to provide a sensor signal indicative of a speed of the motor. The washing machine appliance further includes a motor drive circuit The motor drive circuit includes an inverter configured to provide power to the motor. The motor drive circuit further includes a controller configured to control the inverter. The motor drive circuit further includes a processing circuit configured to process the sensor signal to provide a processed sensor signal. The processing circuit further includes a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor. The processing circuit further includes a second low pass filtering circuit having a second corner frequency greater than the first corner frequency, the second low pass filtering circuit configured to further attenuate the sensor signal when the frequency of the sensor signal is greater than the second corner frequency.

In some examples, the processing circuit is configured to provide the processed sensor signal to the controller, the controller configured to control the inverter based at least in part on the processed sensor signal.

In some examples, the processing circuit is configured to provide the processed sensor signal to the controller as a square wave signal, a frequency of the square wave signal indicative of the speed of the motor.

In some examples, the processing circuit is configured to process the sensor signal during a startup mode of the appliance.

In some examples, the second corner frequency is set such that both the first low pass filter and the second low pass filter are configured to attenuate the sensor signal when the frequency of the sensor signal is within a noise frequency range.

In some examples, the noise frequency range is associated with noise provided by the inverter.

Although specific features of various embodiments may be shown in some drawings and not in others, this is for convenience only. In accordance with the principles of the present disclosure, any feature of a drawing can be referenced and/or claimed in combination with any feature of any other drawing.

While the present subject matter has been described in detail with respect to specific example embodiments thereof, it will be appreciated that those skilled in the art, upon attaining an understanding of the foregoing can readily produce alterations to, variations of, and equivalents to such embodiments. Accordingly, the scope of the present disclosure is by way of example rather than by way of limitation, and the subject disclosure does not preclude inclusion of such modifications, variations and/or additions to the present subject matter as would be readily apparent to one of ordinary skill in the art.

What is claimed is:

1. A motor drive circuit for controlling a motor in an appliance, the motor drive circuit comprising:
an inverter configured to provide power to the motor;
a controller configured to control the inverter;
a processing circuit coupled to a magnetic sensor configured to provide a sensor signal indicative of a speed of the motor, the processing circuit configured to process the sensor signal to provide a processed sensor signal, the processing circuit comprising:
a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor; and
a second low pass filtering circuit having a second corner frequency greater than the first corner frequency, the second low pass filtering circuit configured to further attenuate the sensor signal when the frequency of the sensor signal is greater than the second corner frequency.

2. The motor drive circuit of claim 1, wherein the second corner frequency is set such that both the first low pass filter and the second low pass filter are configured to attenuate the sensor signal when the frequency of the sensor signal is within a noise frequency range.

3. The motor drive circuit of claim 2, wherein the noise frequency range is associated with noise provided by the inverter.

4. The motor drive circuit of claim 1, wherein the processing circuit is configured to provide the processed sensor signal to the controller, the controller configured to control the inverter based at least in part on the processed sensor signal.

5. The motor drive circuit of claim 4, wherein the processing circuit is configured to provide the processed sensor signal to the controller as a square wave signal, a frequency of the square wave signal indicative of the speed of the motor.

6. The motor drive circuit of claim 1, wherein the appliance is a washing machine appliance.

7. The motor drive circuit of claim 1, wherein the processing circuit is configured to process the sensor signal during a startup mode of the appliance.

8. A processing circuit for processing a sensor signal indicative of a speed of a motor provided by a magnetic sensor in an appliance, the processing circuit configured to process the sensor signal to provide a processed sensor signal, the processing circuit comprising:
a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor; and
a second low pass filtering circuit having a second corner frequency greater than the first corner frequency, the second low pass filtering circuit configured to further attenuate the sensor signal when the frequency of the sensor signal is greater than the second corner frequency.

9. The processing circuit of claim 8, wherein the second corner frequency is set such that both the first low pass filter and the second low pass filter are configured to attenuate the sensor signal when the frequency of the sensor signal is within a noise frequency range.

10. The processing circuit of claim 9, wherein the noise frequency range is associated with noise provided by an inverter of the appliance configured to provide power to the motor.

11. The processing circuit of claim 10, wherein the processing circuit is configured to provide the processed sensor signal to a controller of the appliance, the controller configured to control the inverter based at least in part on the processed sensor signal.

12. The processing circuit of claim 11, wherein the processing circuit is configured to provide the processed sensor signal to the controller as a square wave signal, a frequency of the square wave signal indicative of the speed of the motor.

13. The processing circuit of claim 8, wherein the appliance is a washing machine appliance.

14. The processing circuit of claim 8, wherein the processing circuit is configured to process the sensor signal during a startup mode of the appliance.

15. A washing machine appliance, comprising:
a motor;
a magnetic sensor configured to provide a sensor signal indicative of a speed of the motor; and
a motor drive circuit, comprising:
an inverter configured to provide power to the motor;
a controller configured to control the inverter;
a processing circuit configured to process the sensor signal to provide a processed sensor signal, the processing circuit comprising:
a first low pass filtering circuit having a first corner frequency, the first low pass filtering circuit configured to attenuate the sensor signal when a frequency of the sensor signal is greater than the first corner frequency, the first corner frequency set within a sensor frequency range associated with the magnetic sensor; and
a second low pass filtering circuit having a second corner frequency greater than the first corner frequency, the second low pass filtering circuit configured to further attenuate the sensor signal when the frequency of the sensor signal is greater than the second corner frequency.

16. The washing machine appliance of claim 15, wherein the processing circuit is configured to provide the processed sensor signal to the controller, the controller configured to control the inverter based at least in part on the processed sensor signal.

17. The washing machine appliance of claim 16, wherein the processing circuit is configured to provide the processed sensor signal to the controller as a square wave signal, a frequency of the square wave signal indicative of the speed of the motor.

18. The washing machine appliance of claim 15, wherein the processing circuit is configured to process the sensor signal during a startup mode of the appliance.

19. The washing machine appliance of claim 15, wherein the second corner frequency is set such that both the first low pass filter and the second low pass filter are configured to attenuate the sensor signal when the frequency of the sensor signal is within a noise frequency range.

20. The washing machine appliance of claim 19, wherein the noise frequency range is associated with noise provided by the inverter.
